(19) United States
(12) Patent Application Publication
(10) Pub. No.: US 2015/0248227 A1
(43) Pub. Date: Sep. 3, 2015

(54) CONFIGURABLE REUSABLE CONTROLS

(71) Applicant: Microsoft Technology Licensing, LLC, Redmond, WA (US)

(72) Inventors: Anusha Shankar, Woodinville, WA (US); Bharath Swaminathan, Redmond, WA (US)

(21) Appl. No.: 14/302,846

(22) Filed: Jun. 12, 2014

Related U.S. Application Data
(60) Provisional application No. 61/947,190, filed on Mar. 3, 2014.

(51) Int. Cl. G06F 3/0484

(52) U.S. Cl. CPC G06F 3/04847; G06F 3/04842

(57) ABSTRACT

A user interface display is generated that allows a user to provide inputs to identify and configure a control. The user interface display provides user input mechanisms that allow the user to specify either a default or customer rendering for the control, and to bind data to either internal or external data sources. The control is configured based upon the user inputs and stored for use in the computer system.

### CROSS-REFERENCE TO RELATED APPLICATION

The present application is based on and claims the benefit of U.S. provisional patent application No. 61/947,190, filed Mar. 3, 2014, the content of which is hereby incorporated by reference in its entirety.

### BACKGROUND

Computer systems are currently in wide use. Many computer systems are quite large, and have a large number of pages, forms, or other display surfaces.

For instance, some such computer systems include business systems. Business systems can include, for example, enterprise resource planning (ERP) systems, customer relations management (CRM) systems, line-of-business (LOB) systems, among others. These types of systems can have thousands of different forms, each of which have many different controls.

Each user interface surface in a business system also has a plurality of different types of controls. The controls can be drop down menus, text boxes, buttons, or a whole host of other controls. Each control has three parts associated with it. A rendering part is the particular visual display element that represents the control. The control also has a data binding part that binds data to the control, and it can have a business logic part associated with it, that is run in response to user interaction with the control.

Renderings for a control, in current business systems, can only be selected from a list of default renderings. In addition, the controls can only normally be bound to data internal to the business system. In order to bind a control to external data, a developer must first create a window to the data outside of the business system. The external data could then be rendered within that window, but the business system, itself, cannot interact with that data or perform business logic based on that data. Some client devices do not even render the data within such windows.

The discussion above is merely provided for general background information and is not intended to be used as an aid in determining the scope of the claimed subject matter.

### SUMMARY

A user interface display is generated that allows a user to provide inputs to identify and configure a control. The user interface display provides user input mechanisms that allow the user to specify either a default or customer rendering for the control, and to bind data to either internal or external data sources. The control is configured based upon the user inputs and stored for use in the computer system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative business system.

FIG. 2 is a flow diagram illustrating one embodiment of a control configuration and rendering system.

FIG. 3 is a block diagram illustrating components of a configured control.

FIG. 4 is one example of a user interface display that can be displayed to allow user configuration of a control.

FIG. 5 shows the business system of FIG. 1 deployed in a cloud computing architecture.

FIGS. 6-10 show examples of mobile devices.

FIG. 11 is a block diagram of one illustrative computing environment.

### DETAILED DESCRIPTION

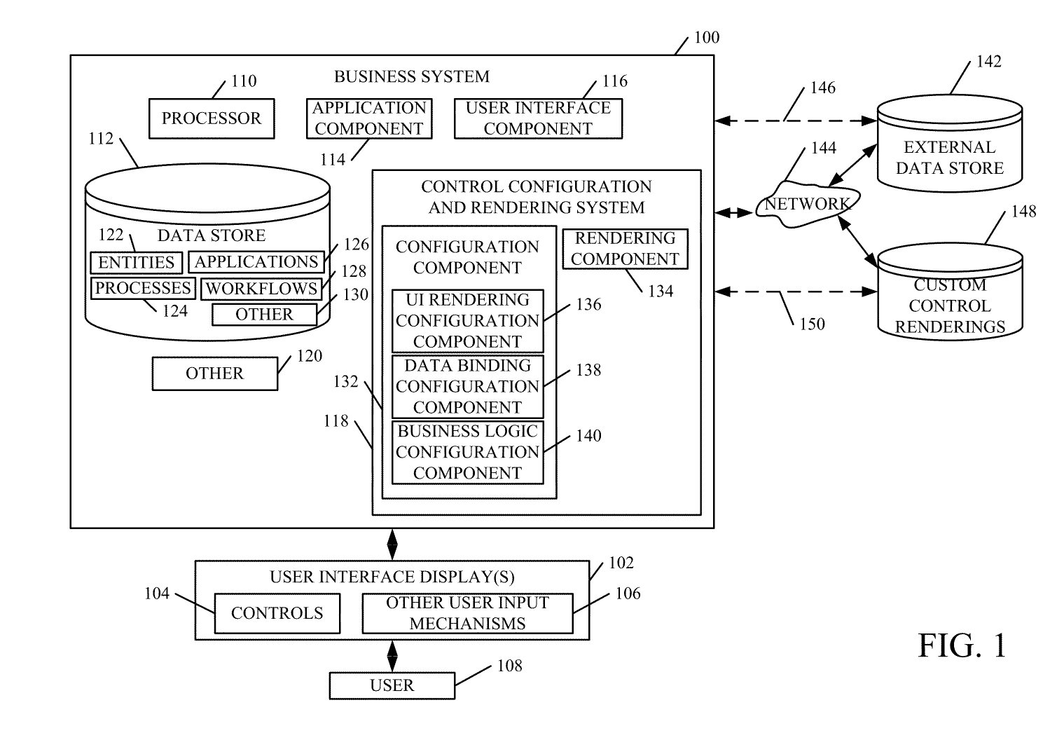

FIG. 1 is a block diagram of one illustrative business system 100. Business system 100 is shown generating user interface displays 102 that can include controls 104, as well as other user input mechanisms 106. User 108 interacts with the user interface displays 102 (such as with the controls 104 and other user input mechanisms 106 on the pages) in order to interact with, and manipulate, business system 100.

Business system 100 illustratively includes processor 110, data store 112, application component 114, user interface component 116 and control configuration and rendering system 118. It can also include other components 120 as well.

Data store 112, itself, illustratively includes entities 122, processes 124, applications 126, workflows 128 and other data records 130. Entities 122 illustratively describe and define entities within business system 100. For instance, a customer entity describes and defines a customer. A vendor entity describes and defines a vendor. An inventory item entity describes and defines an item of inventory. A purchase order entity describes and defines a purchase order. This list is but a small example of the various different types of entities that can be defined within business system 100.

Applications 126 are illustratively business applications, such as general ledger applications, other accounting applications, inventory tracking applications, applications that track opportunities, as well as a host of other business applications. Application component 114 illustratively runs applications 126, which can include business processes 124 and workflows 128. Processes 124 and workflows 128 illustratively operate on business data entities 122 and other business records 130 to enable user 108 to perform his or her tasks within business system 100. The processes and workflows can be automated, semi-automated, or manual.

User interface component 116, either by itself, or under the control of other items in business system 100, illustratively generates user interface displays 102.

Control configuration and rendering system 118 illustratively includes a control configuration component 132 that allows a developer to configure a control, and control rendering component 134 that can be used in rendering the control. Control configuration component 132 illustratively includes user interface (UI) rendering configuration component 136, data binding configuration component 138 and business logic component 140. UI rendering configuration component 136 generates user interface displays with user input mechanisms that allow the user to specify either a default or customized rendering (that is, a visual element that represents the control). Data binding configuration component 138 illustratively generates user interface displays with user input mechanisms that allow a user to bind the control to either internal or external data. Business logic configuration component 140 illustratively generates user interface displays with user input mechanisms that allow a developer to define business logic to be run on the control. FIG. 1 also shows that business system 100 has access to external data sources 142 that can be bound to the controls using data binding configuration component 138. System 100 can access external data stores 142 either over network 144, or directly as indicated by arrow 146.

FIG. 1 further illustrates that system 100 illustratively has access to custom control renderings 148. Again, access can be obtained over network 144, or directly as indicated by arrow 150. Thus, a user can generate custom control renderings and store them in data store 148, and simply access them for a given control using UI rendering configuration component 136. This is described in greater detail below.

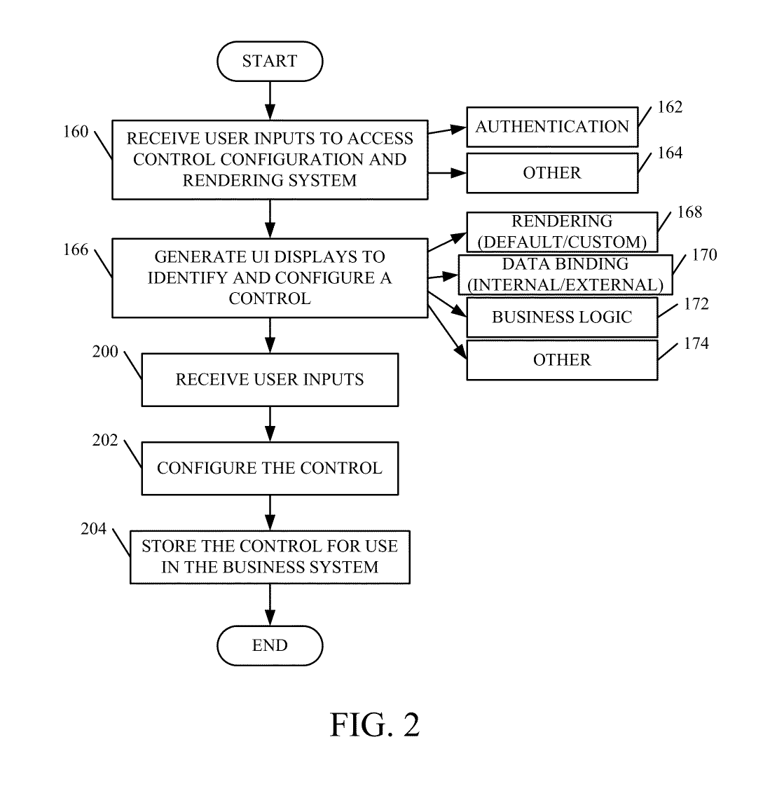

FIG. 2 is a flow diagram illustrating one embodiment of the operation of control configuration and rendering system 118 in allowing a developer (such as user 108) to configure a control. System 100 first receives user inputs indicating that the user wishes to access the control configuration and rendering system 118. This is indicated by block 160 in FIG. 2. Such inputs can include authentication inputs 162 (such as a username and password) or other inputs 164.

System 118 then generates user interface displays with user input mechanisms that allow the user to identify and configure a control. This is indicated by block 166. For instance, the user interface displays can provide user input mechanisms that allow the user to specify a rendering (such as a default or a custom rendering). This is indicated by block 168. They can also allow the user to bind the control to either an internal or external data source, as indicated by block 170. The user input mechanisms also illustratively allow the user to define business logic 172 for the control. They can allow the user to provide other inputs 174 as well.

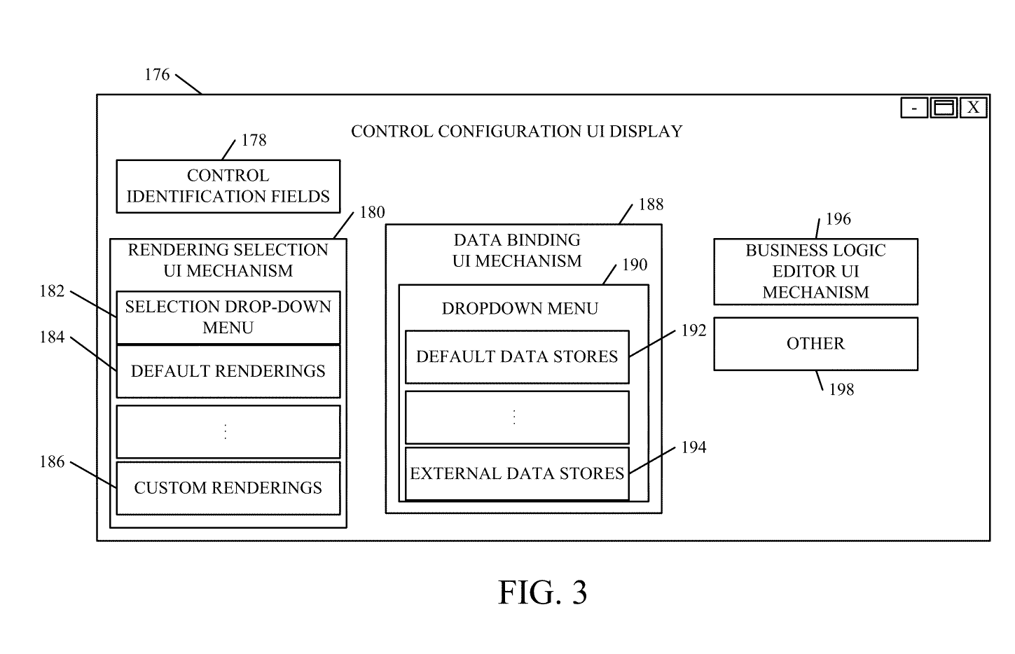

Before continuing with a description of FIG. 2, an exemplary user interface will be described. FIG. 3 shows one embodiment of a user interface display 176 that can be generated to allow a user to configure a control. Display 176 includes a plurality of different user input mechanisms such as control identification fields 178 through which the user can identify the control (this may include such things as providing a name, a control description, etc.). Display 176 also illustratively includes a rendering selection user input mechanism 180. This illustratively allows the user to specify either a default or customized rendering corresponding to the control. In the embodiment shown in FIG. 3, mechanism 180 illustratively includes a selection drop down menu 182 that allows the user to select one of a plurality of default renderings 184, or one of a plurality of different custom renderings 186. The custom renderings can be customized by the user, imported by the user, or generated by the user in other ways.

Display 176 also illustratively includes a data binding user interface mechanism 188. Mechanism 188 illustratively allows the user to specify a data binding in order to bind data to either an internal or external data source. In the embodiment shown in FIG. 3, mechanism 188 illustratively includes a drop down menu 190 that allows the user to select either one of a plurality of default data stores 192 as the location of the data, or one of a plurality of different external data stores 194 as the source for the data. FIG. 3 also shows that display 176 can include a business logic editor user interface mechanism 196 that allows the user to edit business logic performed on the control. Display 176 can include other items 198 as well.

Returning again to the description of the flow diagram in FIG. 2, once the user interface displays are generated, system 118 illustratively receives user inputs. This is indicated by block 200 in FIG. 3. Configuration component 132 then configures the control based upon the user inputs. This is indicated by block 202. System 118 then stores the control for use in business system 100. This is indicated by block 204.

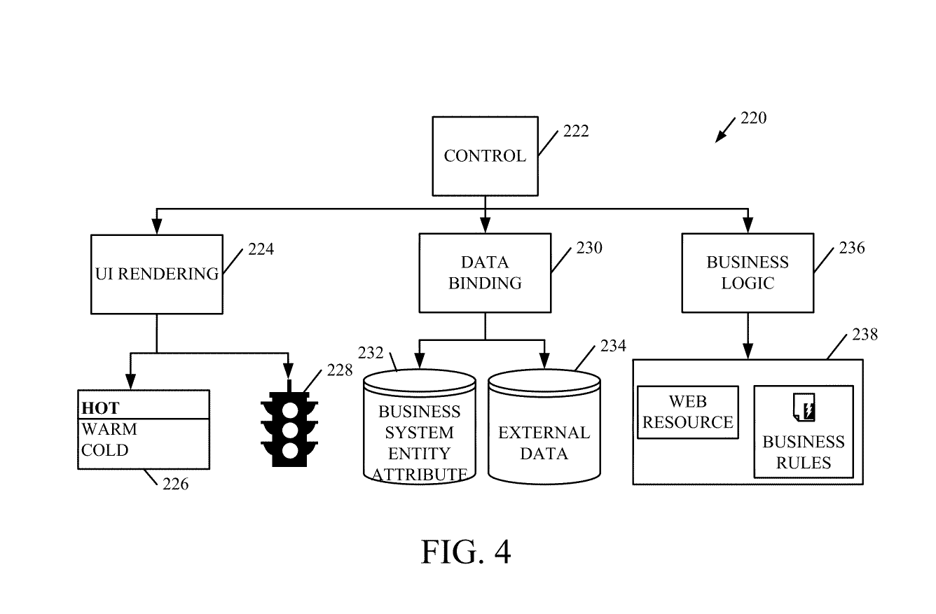

FIG. 4 shows one representation 220 of a control 222. Representation 220 shows that control 222 includes a UI rendering 224 which can be selected from a default rendering 226 and a custom rendering 228. In the embodiment shown in FIG. 4, for instance, the rendering for the control can simply be a textual display indication “hot”, “warm” or “cold”. Alternatively, it can be a custom control represented by a stop light rendering 228.

Control 222 also includes data binding 230 that can be from a data source 232 that is internal to the business system, or an external data source 234. It also illustratively includes a business logic identifier 236 that identifies one or more sources for business logic 238 that can be run on the control 222.

It will be noted that control rendering component 134 is illustratively aware of the data bound to the control, even if it is from an external source. Therefore, it can react to changes in that data based on business logic, or in other ways. This can be done by specifying a particular behavior the external data source is to conform to, and that is expected by component 134. It can be done in other ways as well.

It can thus be seen that the control designer is given a great detail of flexibility. Controls can be rendered using default or custom renderings. The controls can be bound to internal or external data, and the system is aware of, and can act on, the data even if it is from an external source.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

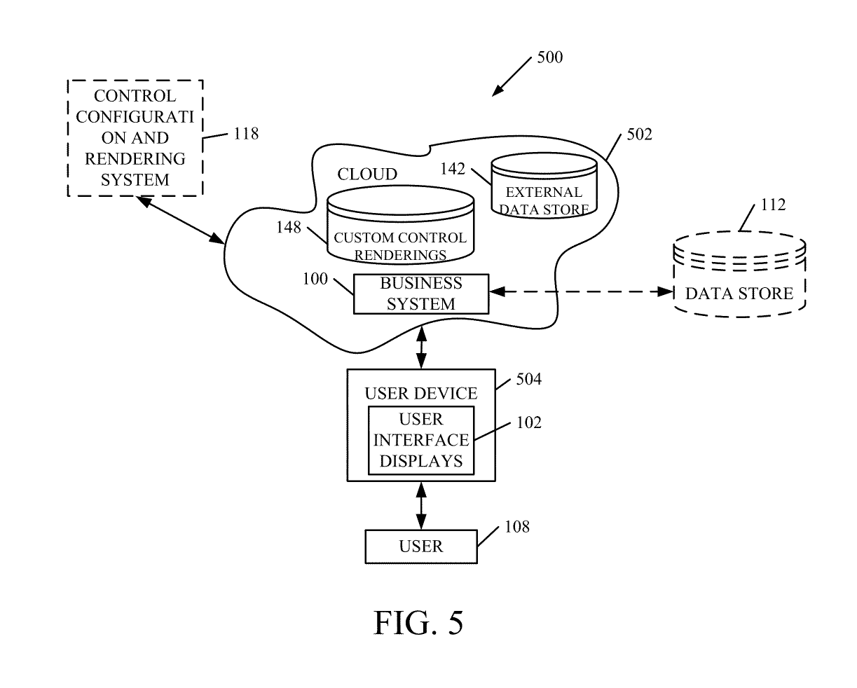

FIG. 5 is a block diagram of business system 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 5, some items are similar to those shown in FIG. 1 and they are similarly numbered. FIG. 5 specifically shows that business system 100 can be located in cloud 502 (which can be public, private, or a combination where portions are public while others are private). Therefore, user 108 uses a user device 504 to access that system through cloud 502.

FIG. 5 also depicts another embodiment of a cloud architecture. FIG. 5 shows that it is also contemplated that some elements of business system 100 are disposed in cloud 502 while others are not. By way of example, data store 112 can be disposed outside of cloud 502, and accessed through cloud 502. In another embodiment, control configuration and rendering component 118 can also be outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

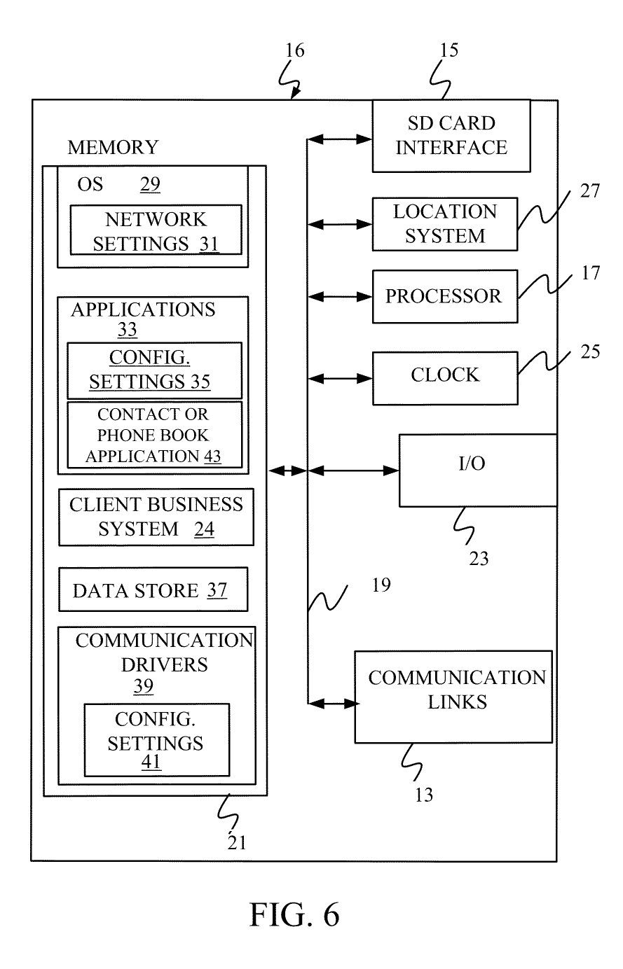

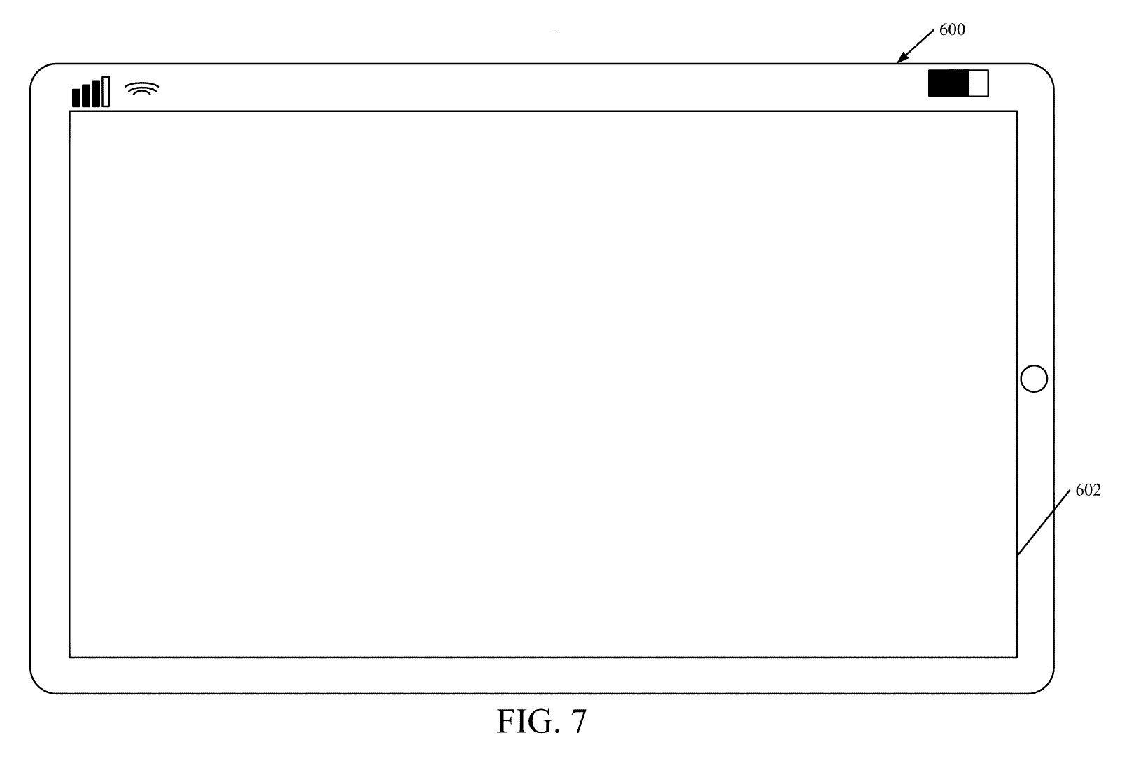

FIG. 6 is a simplified block diagram of one illustrative embodiment of a handheld or mobile computing device that can be used as a user's or client's hand held device 16, in which the present system (or parts of it) can be deployed. FIGS. 7-10 are examples of handheld or mobile devices.

FIG. 6 provides a general block diagram of the components of a client device 16 that can run components of system 100 or that interact with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processor 110 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/0 components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one embodiment in which device 16 is a tablet computer 600. In FIG. 7, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

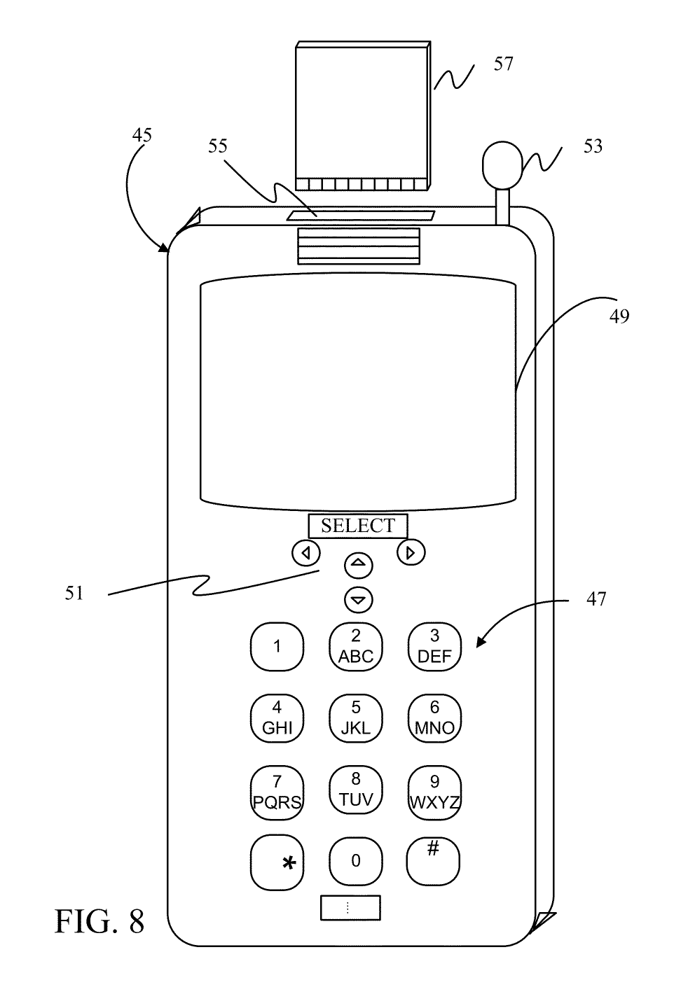

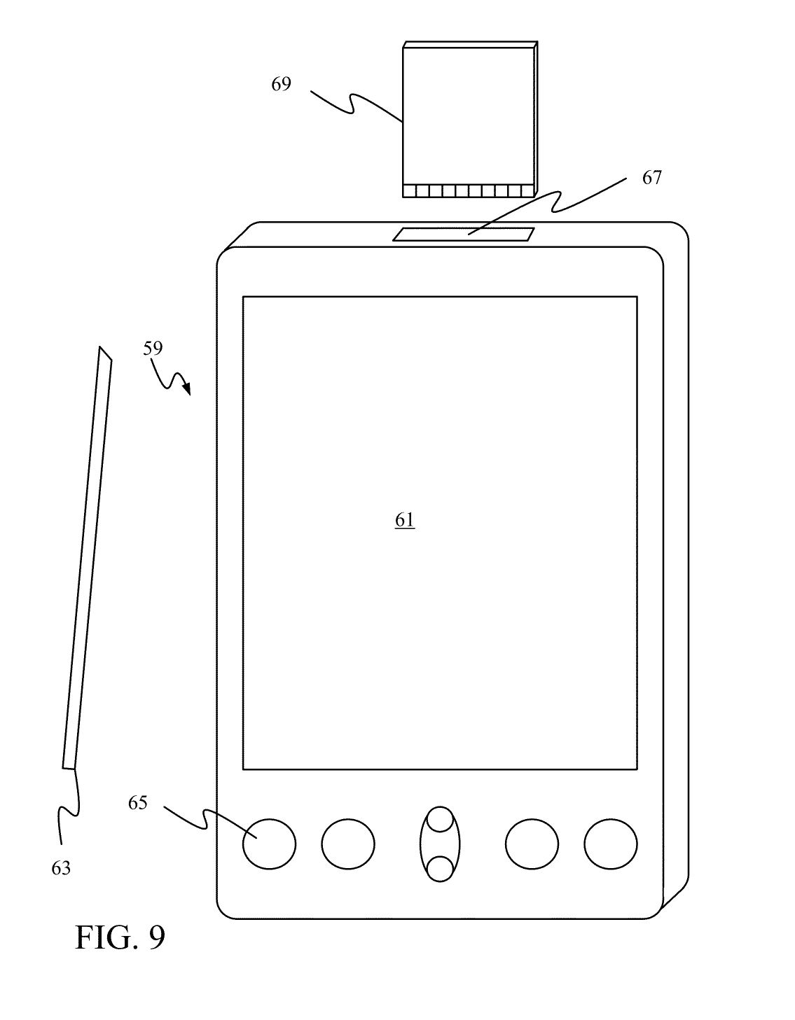

FIGS. 8 and 9 provide additional examples of devices 16 that can be used, although others can be used as well. In FIG. 8, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 9 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

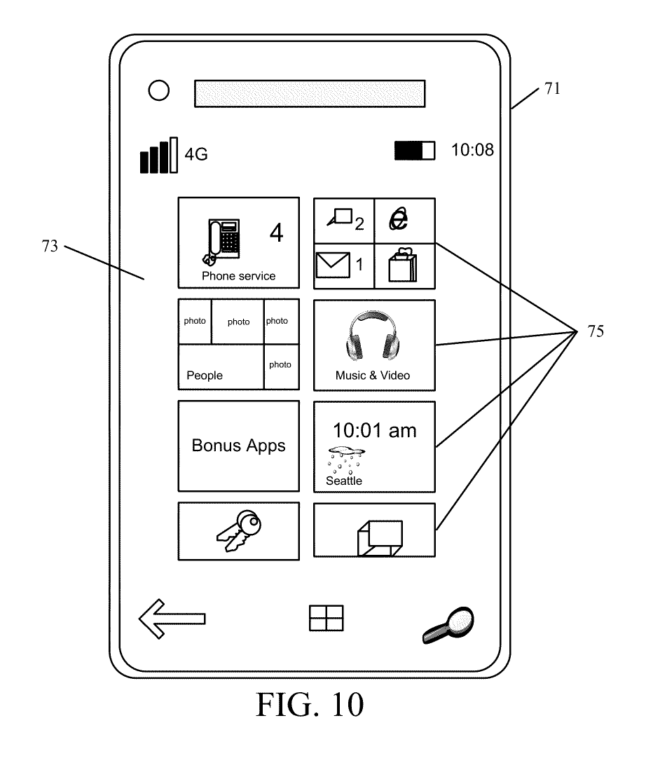

FIG. 10 is similar to FIG. 8 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

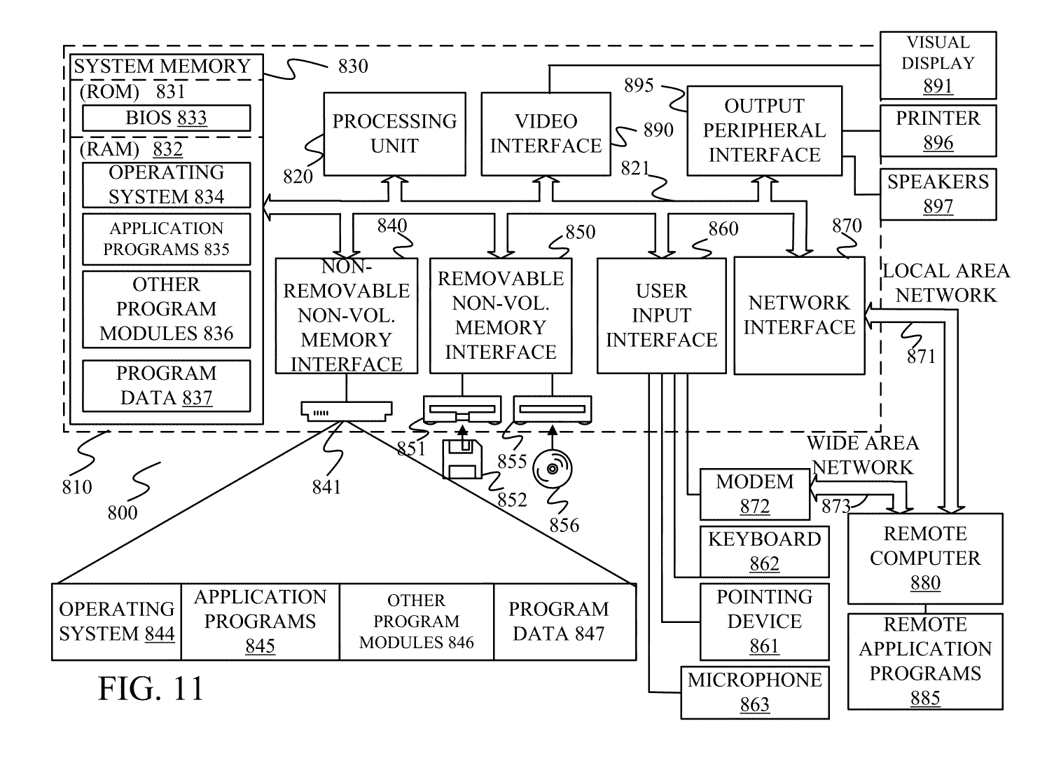

FIG. 11 is one embodiment of a computing environment in which system 100, or parts of it, (for example) can be deployed. With reference to FIG. 11, an exemplary system for implementing some embodiments includes a general-purpose computing device in the form of a computer 810. Components of computer 810 may include, but are not limited to, a processing unit 820 (which can comprise processor 110), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 11 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 11 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented method, comprising:
displaying a user interface display with a control configuration user input mechanism corresponding to a control to be displayed on a display in a computer system;
receiving user actuation of the control configuration user input mechanism; and
in response to receiving the user actuation, configuring the control to render a selected rendering to represent the control on the display.

2. The computer-implemented method of claim 1 wherein the computer system comprises a business system and wherein displaying the user interface display comprises:
displaying a form authoring display with the control configuration user input mechanism that is actuatable to configure the control on a form rendered in the business system.

3. The computer-implemented method of claim 2 wherein displaying the control configuration user input mechanism comprises:
displaying a rendering selection user input mechanism with a selectable customized rendering, selectable to represent the control on the form in the business system.

4. The computer-implemented method of claim 2 wherein displaying the user interface display comprises:
displaying a data binding user input mechanism actuatable to select a data source to bind data to the control;
receiving user actuation of the data binding user input mechanism; and
binding identified data to the control.

5. The computer-implemented method of claim 4 wherein displaying a data binding user input mechanism, comprises:
displaying a data binding selection mechanism with a selectable external data source, selectable to bind the control to a data source external to the business system.

6. The computer-implemented method of claim 5 and further comprising:
receiving user selection of the external data source on the data selection mechanism; and
in response, configuring the control to render data from the external data source on the form of the business system.

7. The computer-implemented method of claim 6 wherein configuring the control to render the data comprises:
configuring the control to recognize data rendered from the external data source; and
using business logic in the business system to interact with the recognized data.

8. A computing device, comprising:
a rendering component that renders a control configuration user interface display with a control configuration user input mechanism to configure a control rendered in a computer system;
a data binding configuration component that receives a control configuration input on the control configuration user input mechanism and binds the control to an external data source, external to the computer system; and
a computer processor that is a functional part of the computer system and activated by the rendering component and the data binding configuration component to facilitate rendering and binding.

9. The computing device of claim 8 wherein the computer system comprises a business system and wherein the control is to be rendered on a form of the business system.

10. The computing device of claim 9 wherein the business system includes business logic that performs operations on data from the external data source.

11. The computing device of claim 9 wherein the rendering component renders the control configuration user interface display with a control rendering selector actuatable to select a rendering for the control on the form.

12. The computing device of claim 11 and further comprising:
a user interface rendering configuration component that receives a user selection input on the control rendering selector and configures the control to be represented by the selected rendering.

13. The computing device of claim 12 wherein the control rendering selector provides, as selectable renderings for the control, a default rendering and a custom rendering specified by the user.

14. The computing device of claim 13 wherein the control rendering selector comprises a menu of selectable renderings.

16. A computer readable storage medium that stores computer executable instructions which, when executed by a computer, cause the computer to perform a method, comprising:
displaying a data binding user input mechanism actuatable to bind a data source to a control rendered on a user interface display of a computer system;
receiving user actuation of the data binding user input mechanism; and
binding data from an external data source, external to the computer system, to the control.

17. The computer readable storage medium of claim 16 wherein the computer system comprises a business system and wherein the control is rendered on a form of the business system.

18. The computer readable storage medium of claim 16 wherein displaying a data binding user input mechanism, comprises:
displaying a data binding selection mechanism with a plurality of different selectable data sources.

19. The computer readable storage medium of claim 18 wherein binding data comprises:
configuring the control to recognize data rendered from the external data source; and
using business logic in the business system to interact with the recognized data.

20. The computer readable storage medium of claim 17 and further comprising:
displaying a rendering selection user input mechanism with a selectable customized rendering, selectable to represent the control on the form in the business system.
in response to receiving a user selection input selecting the customized rendering, configuring the control to render the customized rendering to represent the control on the form of the business system.
